(19) United States
(12) Patent Application Publication
(10) Pub. No.: US 2008/0162965 A1
(43) Pub. Date: Jul. 3, 2008

(54) Managing performance of a processor in a data processing image

(75) Inventors: Catalin Theodor Marinas, Cambridge (GB); Guillaume Jean Letellier, Cottenham (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/785,739

(22) Filed: Apr. 19, 2007

(30) Foreign Application Priority Data
Dec. 29, 2006 (GB) 0626020.2

(51) Int. Cl. G06F 1/26

(52) U.S. Cl. 713/320

(57) ABSTRACT

A data processing apparatus and method are provided for managing performance of a processor. A plurality of predetermined processor performance levels are provided at which the processor may operate. The method comprises the steps of receiving an indication of a required processor performance level, determining a modulation period, and selecting, dependent on the required processor performance level, multiple of the predetermined processor performance levels. Thereafter, a determination operation is performed to determine for each selected predetermined processor performance level a proportion of the modulation period during the which the processor should operate at the predetermined processor performance level. During the modulation period, a modulation operation is performed to switch the processor between the selected predetermined processor performance levels as indicated by the proportions determined by the determination operation. By such an approach, an average performance level can be achieved during the modulation period that matches the required processor performance level, thereby avoiding any unnecessary energy consumption that would otherwise occur if the processor was merely operated at a predetermined processor performance level above the required processor performance level.

### BACKGROUND OF THE INVENTION

1. Field of the Invention

The present invention relates to a data processing apparatus and method for managing performance of a processor.

2. Description of the Prior Art

It is known to provide a data processing apparatus capable of operating at a plurality of different performance levels. A data processing apparatus can typically switch between different processor performance levels at run-time. Lower performance levels are selected when running light workloads to save energy (power consumption) whereas higher performance levels are selected for more processing-intensive workloads. Typically, on a processor implemented in complimentary metal-oxide semi-conductor (CMOS) technology, lower performance levels imply lower frequency and operating voltage settings.

Such known systems are often referred to as Dynamic Frequency Scaling (DFS) or Dynamic Voltage and Frequency Scaling (DVFS) systems, and such systems typically provide a plurality of predetermined processor performance levels at which the processor may operate.

To enable a decision to be made as to which of these predetermined processor performance levels the processor should be run at, it is first necessary to seek to determine a required performance level for the processor having regard to the various tasks that are currently being undertaken by the data processing apparatus. Accordingly, performance level setting policies have been developed which apply algorithms to calculate a required performance level according to characteristics which vary according to different run-time situations. Hence, information about a current run-time situation, for example a processor utilisation value calculated according to a task scheduling algorithm, are input to the performance level setting policies which then employ algorithms to calculate a required performance level.

Unless accurate performance prediction can be made by such performance level setting policies, situations are likely to occur whereby task deadlines are missed as a result of mispredictions. This is in turn detrimental to the processing performance of the data processing system, and thus the quality of service experienced by the user. Accordingly, a number of different performance level setting policies have been developed, and often multiple performance level setting policies are used which are co-ordinated by a policy stack which takes account of the various performance level predictions produced by the performance level setting policies and selects an appropriate required performance level for a given processing situation at run-time. U.S. patent application Ser. No. 10/687,972 provides details of a policy stack and a hierarchy of performance request calculating algorithms that can be used, the contents of this patent application being incorporated herein by reference. Further, U.S. patent application Ser. No. 11/431,928, the contents of which are also incorporated herein by reference, describes a particular performance level setting policy which dynamically calculates at least one performance limit in dependence upon a quality of service value for a processing task.

Typically, once a required performance level has been calculated using the above-described techniques, then if that required performance level falls between the various predetermined processor performance levels, the known systems typically select the next higher predetermined processor performance level, and cause the processor to operate at that predetermined performance level. Accordingly, this leads to wasted energy dissipation, since the processor is run at a performance level higher than that required. One way to seek to alleviate this energy loss would be to provide more predetermined processor performance levels within the system, but this would have an associated hardware cost in providing voltage driver and frequency oscillation circuits that could produce the various voltages and frequencies associated with each predetermined performance level.

GB-A-2,397,143 describes a system which is able to support a range of performance levels without dynamic frequency scaling by switching between a processing mode in which the processing circuit is clocked and a holding mode in which the processing circuit is not clocked. Modulating the switching between the two modes in accordance with a target rate signal indicative of the target rate of data processing system operations allows variable performance to be achieved. The holding mode does not perform any processing since the clock has stopped. Such an approach does not produce direct energy savings, other than a small leakage energy saving by reducing the heat dissipation.

It would be desirable to provide an improved technique for reducing energy loss when managing performance of a processor within a system where a plurality of predetermined processor performance levels are provided at which the processor may operate.

### SUMMARY OF THE INVENTION

Viewed from a first aspect, the present invention provides a method of managing performance of a processor in a data processing apparatus, a plurality of predetermined processor performance levels being provided at which the processor may operate, the method comprising the steps of: receiving an indication of a required processor performance level; determining a modulation period; selecting, dependent on the required processor performance level, multiple of said predetermined processor performance levels; performing a determination operation to determine for each selected predetermined processor performance level a proportion of said modulation period during which the processor should operate at that predetermined processor performance level; and during the modulation period, performing a modulation operation to switch the processor between said selected predetermined processor performance levels as indicated by the proportions determined by the determination operation.

In accordance with the present invention, multiple of the predetermined processor performance levels are selected, and then a determination operation is performed to divide up the modulation period amongst those selected predetermined processor performance levels, such that during each modulation period, the processor is switched between those selected predetermined processor performance levels in a manner indicated by the result of the determination operation. Accordingly, such a technique causes a controlled oscillation to be performed between the selected predetermined processor performance levels with the aim of achieving an average level of performance corresponding to the required processor performance level. The processor continues to operate for the whole modulation period and accordingly does useful work during the entire modulation period, as contrasted with the technique in GB-A-2,397,143 where the processor only operates during the processing mode and is turned off during the holding mode. Further, as mentioned earlier the technique in GB-A-2,397,143 does not support dynamic frequency scaling and hence does not provide multiple predetermined processor performance levels at which the processor may operate.

The proportions calculated by the determination operation can be expressed in absolute terms, for example specifying particular amounts of time (e.g. so many milliseconds), in which event the modulation period needs to be available before performing the determination operation. However, alternatively, the proportions can be expressed as percentages of the modulation period, in which case the determination operation can occur in parallel with, or before, determination of the modulation period.

Whilst there are a number of ways in which the multiple predetermined processor performance levels may be selected prior to performing the determination operation, in one embodiment the selecting step comprises selecting a first predetermined processor performance level higher than said required processor performance level and a second predetermined processor performance level lower than said required processor performance level. The purpose of the modulation technique of the present invention is to save energy by obtaining an average performance level across the modulation period that is closer to the required processor performance level than would be the case if merely a predetermined processor performance level above the required processor performance level were selected. However, the modulation itself consumes some energy due to the switching required, but by modulating between just two predetermined processor performance levels, one above the required processor performance level and one below the required processor performance level, this reduces the energy consumed by the modulation operation. In one particular embodiment, the first and second predetermined processor performance levels are those processor performance levels either side of the required processor performance level. Accordingly, by way of example, if a system has four predetermined processor performance levels labelled levels one to four, with level one being the highest performance level, and the required processor performance level is less than predetermined processor performance level two but higher than predetermined processor performance level three, then levels two and three will be selected and the modulation operation used to switch between those two levels.

In one embodiment, the determination operation determines a first part of the modulation period during which the processor is operated at one of said first or second predetermined processor performance levels, for the remainder of the modulation period the processor being operated at said other of said first or second predetermined processor performance levels. Hence, a single switch occurs during the modulation period, thereby minimising the energy consumed by performing switching.

Which of the two selected predetermined processor performance levels is used during the first part of the modulation period is a matter of design choice. However, in one embodiment, during the modulation period the processor is operated at said first predetermined processor performance level during the first part of the modulation period, and at the second predetermined processor performance level during the remainder of the modulation period. Hence, in such embodiments, the higher of the two selected predetermined processor performance levels is used in the first part of the modulation period. By such an approach, it is easier for the performance management process to respond to changes in required processor performance level, particularly changes which require an increased processor performance level, since higher performance is provided in the earlier part of the modulation period than is provided in a later part of the modulation period. Such a change in required processor performance level can be responded to in a variety of ways. According to one approach, the current modulation period could be abandoned and a new modulation period started. As an optional addition to that approach, a compensation operation could be performed to compensate for the extra performance in the previous modulation period (since it was not completed and hence the average performance would have been higher than if it had been completed). As an alternative approach, the performance management process waits for the current modulation period to complete and then is repeated again having regard to the newly received required processor performance level. This latter approach is simpler to implement and in most situations will produce results that meet the requirements of the system.

The manner in which the modulation period is determined can take a variety of forms. As mentioned earlier, the switching that occurs as a result of the modulation operation will itself consume some energy, and accordingly as the modulation period increases, the frequency of the switching decreases, and accordingly the energy consumed by the modulation process is reduced. However, as a result of the modulation operation, the processor is driven for part of the modulation period at a predetermined performance level lower than the required processor performance level, and if the processor spends too long at the lower predetermined performance level it is possible that tasks will start to fail their deadline requirements. Such deadline requirements may be expressed in absolute terms, i.e. task A must always complete in time period X, or may be expressed in a quality of service form, e.g. task A must 90% of the time complete within time period Z. Accordingly, there is an upper limit on how long the modulation period can be. It is important to ensure that the modulation performed enables the deadline requirements to be met for any combination of active tasks in the system.

In accordance with one embodiment, the step of determining the modulation period comprises: for each of said tasks, determining a task deadline corresponding to a time interval within which said task should have been completed by said data processing apparatus; and selecting as said modulation period the smallest of the determined task deadlines. This modulation period determining technique ensures a safe modulation period is chosen where any combination of active tasks will meet their deadline requirements.

Task deadlines provide a convenient way of quantitatively assessing the quality of service, since if a given processing task does not meet its task deadline then there are likely to be implications for the quality of service such as delays in the supply of data generated by the given processing task and supplied as input to related processing tasks.

In one embodiment of this type, the task deadline is associated with an interactive task and corresponds to a smallest one of: (i) a task period; and (ii) a value specifying an acceptable response time for a user. This provides a convenient quality of service measure for applications where the response time of the data processing system to interactions with the user has an impact on the perceived quality of service.

Whilst the above described technique for determining the modulation period results in a modulation period which will always enable the deadline requirements to be met for any combination of active tasks, it is possible that the modulation period determined by such an approach is actually less than it could in practice be whilst still enabling the deadline requirements to be met, and accordingly could lead to unnecessary energy consumption due to switching between performance levels more often than is in fact needed. In accordance with an alternative embodiment, the step of determining the modulation period comprises: for each of said tasks: (i) determining a task deadline corresponding to a time interval within which said task should have been completed by said data processing apparatus; (ii) receiving a minimum processor performance level for said task assuming said task deadline; and (iii) if said minimum processor performance level is greater than the lowest of said selected predetermined processor performance levels, determining a task modulation period for said task; selecting as said modulation period the smallest of said determined task modulation periods. As used herein, the term “task modulation period” means the modulation period of a task.

In accordance with this technique, the modulation period determined will be larger than or equal to the smallest of the determined task deadlines and hence allows a modulation period which is greater than or equal to (it will be equal to for the special case where there is only one active task) the smallest of the determined task deadlines without having any adverse impact on the meeting of deadline requirements for any combination of active tasks in the system. Hence, considering a system based on quality of service requirements, such an approach can allow a larger modulation period to be determined without affecting the quality of service requirements at any moment.

In one embodiment, at said step (iii) the task modulation period is determined by the equation:

t_{LOW}=(P_{HIGH}−P_{CPU})/(P_{HIGH}−P_{LOW})*T

where:
T_{MOD}(n) is the task modulation period;
P_{HIGH} is a selected first predetermined processor performance level above said required processor performance level;
P_{MIN}(Tₙ) is the minimum processor performance level for the task;
P_{CPU} is the required processor performance level; and
Tₙ is the task deadline.

The minimum processor performance level required by the above modulation period determining technique can be obtained in a variety of ways. For example, when certain types of task scheduler are used in order to schedule the tasks for execution by the processor, then known algorithms can be used to detect the minimum processor performance level. Examples of such schedulers that readily allow such a determination are a Rate Monotonic scheduler or an Earliest Deadline First scheduler. Additionally, the technique described in the earlier-mentioned U.S. patent application Ser. No. 11/431,928 enables a minimum processor performance level to be calculated when using any general purpose scheduler.

The indication of a required processor performance level can be obtained from a variety of sources. However, in one embodiment, the indication of a required processor performance level is received from a performance setting routine executed by the processor. There are many known routines for determining required performance levels, and the above-mentioned U.S. patent application Ser. No. 11/431,928 describes one such performance setting routine that is based on quality of service considerations. Hence, in one embodiment, the performance setting routine may apply a quality of service policy in order to determine the required processor performance level.

The processor performance levels can be specified in a variety of ways. However, in one embodiment, each predetermined processor performance level has an associated operating frequency at which the processor is operated if that predetermined processor performance level is selected for the processor. Additionally, in one embodiment, each predetermined processor performance level further has an associated supply voltage provided to the processor if that predetermined processor performance level is selected for the processor. Hence, in such embodiments both frequency and voltage scaling are used to provide the various predetermined processor performance levels.

Viewed from a second aspect, the present invention provides a computer program product comprising a computer program on a computer readable medium which when executed on a data processing apparatus performs a method of managing performance of a processor, a plurality of predetermined processor performance levels being provided at which the processor may operate, the computer program performing the steps of: receiving an indication of a required processor performance level; determining a modulation period; selecting, dependent on the required processor performance level, multiple of said predetermined processor performance levels; performing a determination operation to determine for each selected predetermined processor performance level a proportion of said modulation period during which the processor should operate at that predetermined processor performance level; and during the modulation period, performing a modulation operation to switch the processor between said selected predetermined processor performance levels as indicated by the proportions determined by the determination operation.

Viewed from a third aspect, the present invention provides a data processing apparatus comprising: processor means; control means for operating the processor at a selected one of a plurality of predetermined processor performance levels; means for determining a required processor performance level; means for determining a modulation period; means for selecting, dependent on the required processor performance level, multiple of said predetermined processor performance levels; and means for performing a determination operation to determine for each selected predetermined processor performance level a proportion of said modulation period during which the processor should operate at that predetermined processor performance level; the control means, during the modulation period, performing a modulation operation to switch the processor means between said selected predetermined processor performance levels as indicated by the proportions determined by the determination operation.

The modulation operation may in one embodiment be performed by software executing on the processor. However, in an alternative embodiment, the modulation operation may be performed by a hardware.

Viewed from a fourth aspect, the present invention provides a data processing apparatus comprising: a processor; and control circuitry for operating the processor at a selected one of a plurality of predetermined processor performance levels; the processor being arranged to perform operations to produce an indication of a required processor performance level, a modulation period, and to select, dependent on the required processor performance level, multiple of said predetermined processor performance levels, the processor further arranged to perform a determination operation to determine for each selected predetermined processor performance level a proportion of said modulation period during which the processor should operate at that predetermined processor performance level; the control circuitry including modulation circuitry for performing, during the modulation period, a modulation operation to switch the processor between said selected predetermined processor performance levels as indicated by the proportions determined by the determination operation. In accordance with this aspect of the invention, hardware modulation circuitry is provided for performing the modulation operation.

### BRIEF DESCRIPTION OF THE DRAWINGS

The present invention will be described further, by way of example only, with reference to embodiments thereof as illustrated in the accompanying drawings, in which:

FIG. 1 schematically illustrates an example of a data processing apparatus in which the performance management techniques of embodiments of the present invention may be employed;

FIG. 2 schematically illustrates elements of the data processing apparatus used in one embodiment of the present invention to perform performance management of the processor of FIG. 1;

FIG. 3 schematically illustrates modulation performed between two predetermined processor performance levels during the modulation period in accordance with one embodiment of the present invention;

FIG. 4 is a flow diagram illustrating the steps performed in one embodiment of the present invention in order to determine the period of time t_{HIGH} of FIG. 3 in accordance with one embodiment of the present invention;

FIG. 5 is a flow diagram illustrating the steps performed in one embodiment of the present invention to modulate between the two predetermined processor performance levels illustrated in FIG. 3;

FIG. 6 schematically illustrates the scheduling of a task and the determination of a task period for that scheduled task;

FIG. 7 is a flow diagram illustrating the steps performed to determine a modulation period in accordance with one embodiment of the present invention;

FIG. 8 is a block diagram illustrating elements provided within the voltage and frequency supply circuits of FIG. 1 in accordance with one embodiment of the present invention;

FIG. 9 is a diagram illustrating in more detail components provided within the pulse width modulation (PWM) circuit of FIG. 8 in accordance with one embodiment of the present invention;

FIG. 10 schematically illustrates a data processing system capable of dynamically varying a performance range from which a performance level is selected;

FIG. 11 schematically illustrates execution of two different processing tasks in the data processing system of FIG. 10;

FIG. 12 is a graph of the probability of meeting a task deadline against the processor frequency in MHz; and

FIG. 13 is a flow chart that schematically illustrates how the first performance setting policy 1156 of FIG. 10 performs dynamic frequency scaling to dynamically vary the performance range.

### DESCRIPTION OF EMBODIMENTS

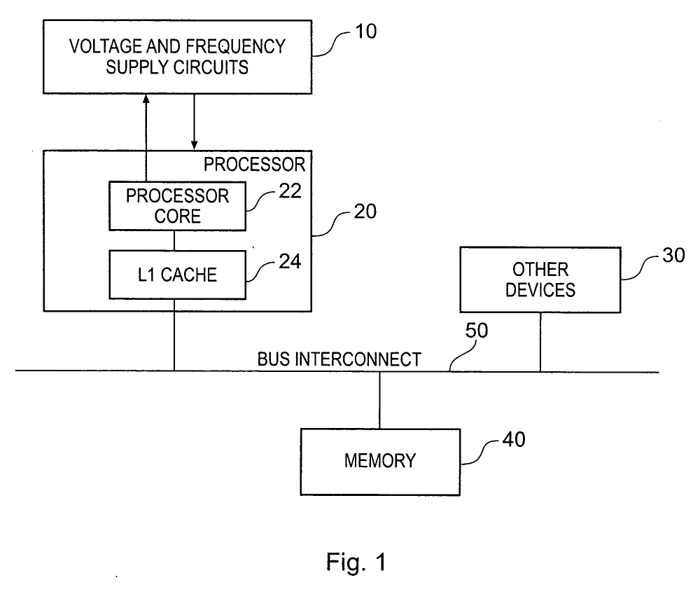

FIG. 1 is a block diagram illustrating one example of a data processing apparatus in which the performance management techniques of embodiments of the present invention may be employed. As shown in FIG. 1, a processor 20 is provided having a processor core 22 coupled to a level one data cache 24, the data cache 24 being used to store data values for access by the processor core 22 when performing data processing operations. The processor 20 is connected to a bus interconnect 50 via which it can be coupled with other devices 30, and with a memory system 40. One or more further levels of cache (not shown) may be provided between the processor 20 and the memory system 40, either on the processor side of the bus 50 or on the memory system side of the bus 50. The other devices 30 can take a variety of forms, and hence can for example be other master devices initiating transactions on the bus interconnect 50, and/or one or more slave devices used to process transactions issued by master devices on the bus interconnect 50. The processor 20 is an example of a master device, and it will be appreciated that one or more of the other devices 30 may be another processor constructed similarly to processor 20.

Voltage and frequency supply circuits 10 are provided for controlling the voltage and frequency supplied to the processor 20 according to a selected processor performance level. In particular, the processor may operate at any of a number of different predetermined processor performance levels, each predetermined processor performance level having an associated supply voltage and operating frequency, and the voltage and frequency supply circuits 10 being able to provide to the processor 20 the required supply voltage and operating frequency dictated by the currently selected predetermined processor performance level. The performance levels can be varied at run-time, and typically a number of routines are executed on the processor core 22 to periodically evaluate the appropriate processor performance level, and to output signals to the voltage and frequency supply circuits 10 to indicate any required change to a different predetermined processor performance level.

The processor core 22 may also execute routines in order to determine appropriate voltage and frequency supply levels for other components in the data processing apparatus, i.e. components other than the processor 20, and the voltage and frequency supply circuits 10 may be arranged to alter the voltage and frequency supplied to those other components accordingly. However, for the purposes of considering an embodiment of the present invention, the performance management techniques described herein are aimed at controlling the performance level of the processor 20 dependent on a required processor performance level determined by performance setting routines executed on the processor core 22.

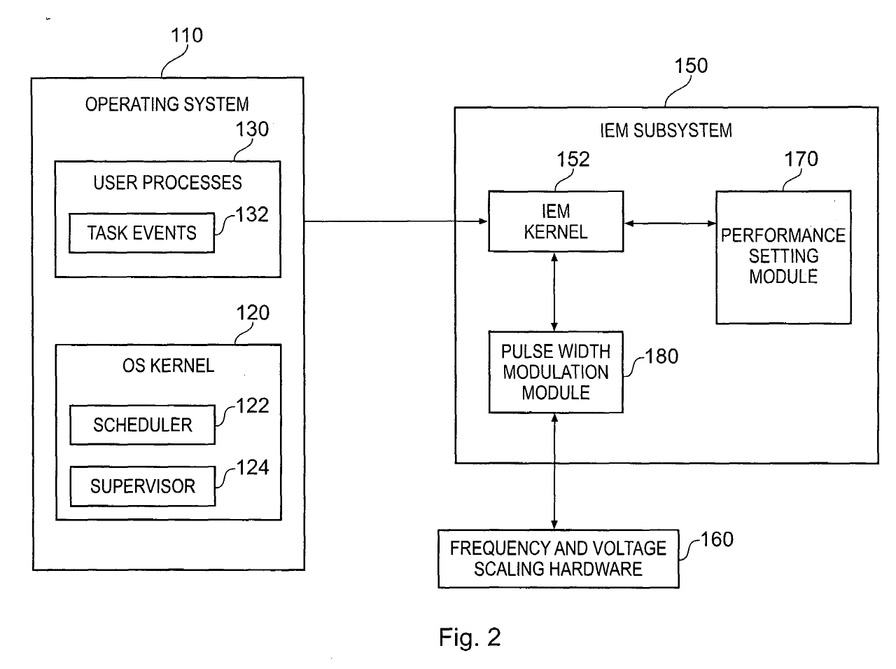

FIG. 2 schematically illustrates in more detail components of a data processing system that enables a processor to be operated at a plurality of different performance levels, the system comprising an intelligent energy management subsystem operable to perform selection of a performance level to be used by the data processing system. In an example implementation where the system of FIG. 2 is implemented within the apparatus of FIG. 1, all of the components of FIG. 2 other than the frequency and voltage scaling hardware 160 are in one embodiment implemented by software routines executing on the processor core 22 of FIG. 1, and the frequency and voltage scaling hardware 160 is in one embodiment provided within the voltage and frequency supply circuits 10 of FIG. 1.

The data processing system comprises an operating system 110 comprising a user processes layer 130 having task events 132 associated therewith. The operating system 110 also comprises an operating system kernel 120 having a scheduler 122 and a supervisor 124. The data processing system comprises an intelligent energy management (IEM) subsystem 150 comprising an IEM kernel 152, a performance setting module 170 and a pulse width modulation (PWM) module 180. Frequency and voltage scaling hardware 160 is also provided as part of the data processing apparatus.

The operating system kernel 120 is the core that provides basic services for other parts of the operating system 110. The kernel can be contrasted with the shell (not shown) which is the outermost part of the operating system that interacts with user commands. The code of the kernel is executed with complete access privileges for physical resources, such as memory, on its host system. The services of the operating system kernel 120 are requested by other parts of the system or by an application program through a set of program interfaces known as a system core. The scheduler 122 determines which programs share the kernel's processing time and in what order. The supervisor 124 within the kernel 120 provides access to the processor by each process at the scheduled time.

The user processes layer 130 monitors processing work performed by the data processing system via system call events and processing task events including task switching, task creation and task exit events and also via application-specific data. The task events 132 represent processing tasks performed as part of the user processes layer 130.

The intelligent energy management subsystem 150 is responsible for calculating a required processor performance level, for determining a modulation period, and for performing calculations to control switching between two predetermined processor performance levels during that modulation period in order to seek to achieve the required processor performance level. The performance setting module 170 may comprise a policy stack having a plurality of performance level setting policies each of which uses a different algorithm to calculate a target performance level according to different characteristics according to different run-time situations. The policy stack co-ordinates the performance setting policies and takes account of different performance level predictions to select an appropriate performance level for a given processing situation at run-time. In effect the results of the different performance setting policy modules are collated and analysed to determine a global estimate for a target processor performance level.

Such a policy stack is described in more detail in copending U.S. patent application Ser. No. 11/431,928, the contents of which are incorporated herein by reference, and whose embodiment description is included as Appendix 1 at the end of the embodiment description of the present application. In accordance with the technique described therein, the first performance setting policy is operable to calculate at least one of a maximum processor frequency and a minimum processor frequency in dependence upon a quality of service value for a processing task. The IEM subsystem 150 is operable to dynamically vary the performance range of the processor in dependence upon at least one of these performance limits (i.e. maximum and minimum frequencies). In embodiments where a plurality of performance setting policies are provided, the various policies are organised into a decision hierarchy (or algorithm stack) in which the performance level indicators output by algorithms at upper (more dominant) levels of the hierarchy have the right to override the performance level indicators output by lower (less dominant) levels of the hierarchy. Examples of different performance setting policies include: (i) an interactive performance level prediction algorithm which monitors activity to find episodes of execution that directly impact the user experience and ensures that these episodes complete without undue delay; (ii) an application-specific performance algorithm that collates performance information output by application programs that have been adapted to submit (via system calls) information with regard to their specific performance requirements to the IEM subsystem 150; and (iii) a perspectives based algorithm that estimates future utilisation of the processor based on recent utilisation history.

Details of the policy stack and the hierarchy of performance request calculating algorithms are described in U.S. patent application Ser. No. 10/687,972, which is incorporated herein by reference. In accordance with the technique described in U.S. application Ser. No. 11/431,928, the first performance level setting policy, which dynamically calculates at least one performance limit (minimum or maximum frequency) in dependence upon a quality of service value for a processing task, is at the uppermost level of the policy stack hierarchy. Accordingly, it constrains the currently selected processor performance level such that it is within the currently set performance limit(s) (maximum and/or minimum frequencies of range) overriding any requests from other algorithms of the policy stack to set the actual performance level to a value that is less than the minimum acceptable frequency or greater than the maximum acceptable frequency calculated by the first performance setting policy. The performance setting policies of the policy stack can be implemented in software, hardware or a combination thereof (e.g. in firmware).

The operating system 110 supplies to the IEM kernel 152 information with regard to operating system events such as task switching and the number of active tasks in the system at a given moment. The IEM kernel 152 in turn supplies the task information and the operating system parameters to the performance setting module 170. The performance setting module 170 uses the information received from the IEM kernel in order to calculate appropriate processor performance levels in accordance with the algorithms of the respective performance setting policies. Each of the performance setting policies supplies to the IEM kernel 152 a calculated required performance level and the IEM kernel manages appropriate selection of a global required processor performance level.

Once the global required processor performance level has been determined, that level is forwarded from the IEM kernel 152 to the PWM module 180. As will be discussed in more detail later, the PWM module is arranged to select based on the required processor performance level a predetermined processor performance level above the required processor performance level and a predetermined processor performance level below the required processor performance level. The PWM module 180 may itself retain information about the available predetermined processor performance levels, or alternatively it can obtain this information from the frequency and voltage scaling hardware 160.

The PWM module 180 is also arranged to determine a modulation period and to then determine for each of the two selected predetermined processor performance levels the proportion of the modulation period that the processor should operate at that predetermined processor performance level. The PWM module 180 can then either perform a modulation operation to switch the processor between the selected predetermined processor performance levels and send the appropriate drive signals to the frequency and voltage scaling hardware 160, or alternatively the actual modulation can be performed by hardware circuitry within the frequency and voltage scaling hardware 160 based on timing information and an indication of the selected predetermined processor performance levels output by the PWM module 180 to the frequency and voltage scaling hardware 160. By performing such modulation between two selected predetermined processor performance levels, a controlled oscillation can be performed between those predetermined processor performance levels with the aim of achieving an average level of performance corresponding to the required processor performance level indicated by the IEM kernel 152.

In accordance with embodiments of the present invention, both frequency and voltage are scaled dependent on the selected processor performance level. When the processor frequency is reduced, the voltage may be scaled down in order to achieve energy savings. For processor implemented in complimentary metal-oxide semiconductor (CMOS) technology, the energy used for a given workload is proportional to voltage squared.

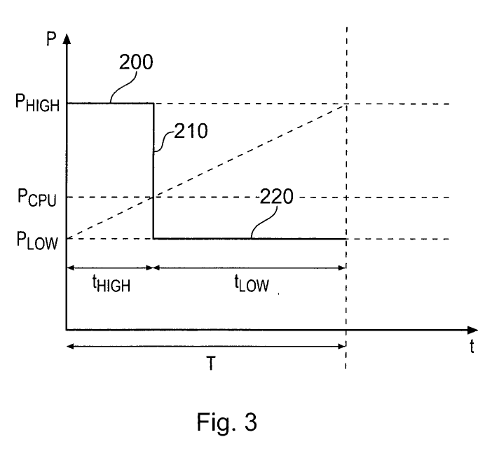

FIG. 3 is a graph showing processor performance against time. For a determined modulation period T, the performance level is modulated between a performance level (P_{HIGH}) above the required processor performance level (P_{CPU}) and a performance level (P_{LOW}) below the required processor performance level. In particular, once the PWM module 180 has selected the performance levels P_{HIGH} and P_{LOW}, it determines the proportion of the modulation period T that should be spent at the performance level P_{HIGH}, this proportion being referenced in FIG. 3 as t_{HIGH}, and the proportion of the modulation period that should be spent at the lower performance level P_{LOW}, this proportion being referred to in FIG. 3 as t_{LOW}. It will be appreciated that the parameters t_{HIGH} and t_{LOW} can be calculated in absolute terms, i.e. as certain amounts of time, in which event it is necessary to know the modulation period T before performing the determination of those parameters. However, alternatively, the parameters t_{HIGH} and t_{LOW} can be calculated in percentage terms, and accordingly the determination can take place in parallel with, or before, the modulation period T is determined. It will also be appreciated that only one of the parameters t_{HIGH} and t_{LOW} needs to actively be determined, since the other can be inferred from the modulation period T.

Hence, as shown in FIG. 3, once the parameters t_{HIGH} and t_{LOW} have been determined, the performance level can be modulated, so that for the period t_{HIGH} the performance level is at the level 200 shown in FIG. 3, whereafter it transitions at point 210 to the lower performance level 220, which is then maintained for the remainder of the modulation period T.

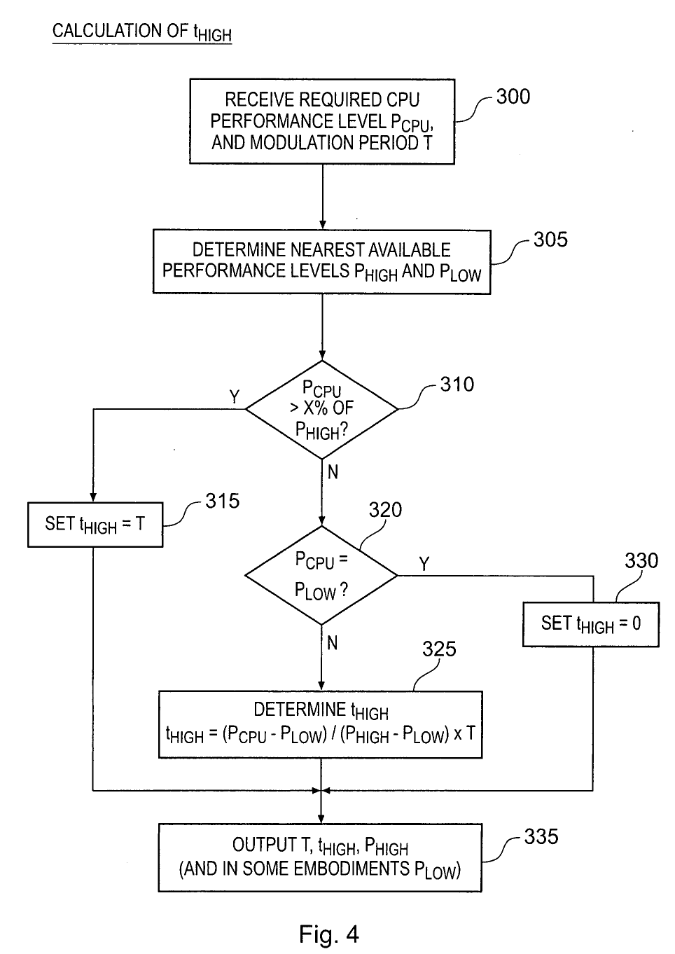

FIG. 4 is a flow diagram illustrating the steps performed by the PWM module 180 of FIG. 2 in order to determine the parameter t_{HIGH}. In this example, it is assumed that t_{HIGH} is computed in absolute terms, and accordingly at step 300 the process receives not only the required CPU performance level but also the modulation period. Thereafter, at step 305, the nearest available predetermined performance levels P_{HIGH} and P_{LOW} are determined.

Thereafter, at step 310, it is determined whether the required CPU performance level P_{CPU} is greater than a predetermined percentage of the higher selected processor performance level P_{HIGH}. If it is, then the process branches to step 315, where the parameter t_{HIGH} is set equal to the modulation period T. The percentage used at step 310 is typically a high percentage, such that at step 310 it is determined whether the required processor performance level is deemed close to the upper predetermined performance level P_{HIGH}. If it is close to the upper performance level P_{HIGH}, it is considered that it is not worth seeking to improve energy consumption by performing the modulation technique, since energy will in any case be consumed by performing the modulation technique, and this could in such circumstances negate any potential benefit. Instead, by merely setting t_{HIGH} equal to the modulation period T, this means that for the entire modulation period the performance level is set to P_{HIGH}, and no switching is required.

Assuming at step 310 it is determined that the required processor performance level is not close to the upper performance level P_{HIGH}, then the process proceeds to step 320, where it is determined whether the required processor performance level is equal to the lower predetermined performance level P_{LOW}. If it is, then t_{HIGH} is set equal to zero at step 330, thereby ensuring that the period t_{LOW} is set equal to the modulation period T, i.e. the performance level P_{LOW} will be used for the entirety of the modulation period, hence avoiding the need for any switching.

However, assuming that it is determined at step 320 that the required processor performance level is not equal to P_{LOW}, then the process proceeds to step 325, where the parameter t_{HIGH} is computed according to the equation:

t_{HIGH}=(P_{CPU}−P_{LOW})/(P_{HIGH}−P_{LOW})*T

Thereafter, at step 335, the process outputs the modulation period T, the computed parameter t_{HIGH}, and an indication of the upper predetermined performance level P_{HIGH}. Additionally, in some embodiments, the process may also output at this point an indication of the lower predetermined performance level P_{LOW}. In particular, in one embodiment where the modulation is actually performed in software, it is considered appropriate to output both P_{HIGH} and P_{LOW}. However, in an embodiment where the modulation is performed by hardware, it may be necessary only to output one of the two predetermined performance levels, with the other being inferred by the hardware.

It will also be appreciated that whilst in FIG. 4 the parameter t_{HIGH} was computed, in an alternative embodiment the parameter t_{LOW} could be computed. In such an embodiment, at step 315 t_{LOW} would be set equal to zero, and at step 330 t_{LOW} would be set equal to T. Similarly, the equation at step 325 would be replaced by the following equation:

t_{LOW}=(P_{HIGH}−P_{CPU})/(P_{HIGH}−P_{LOW})*T

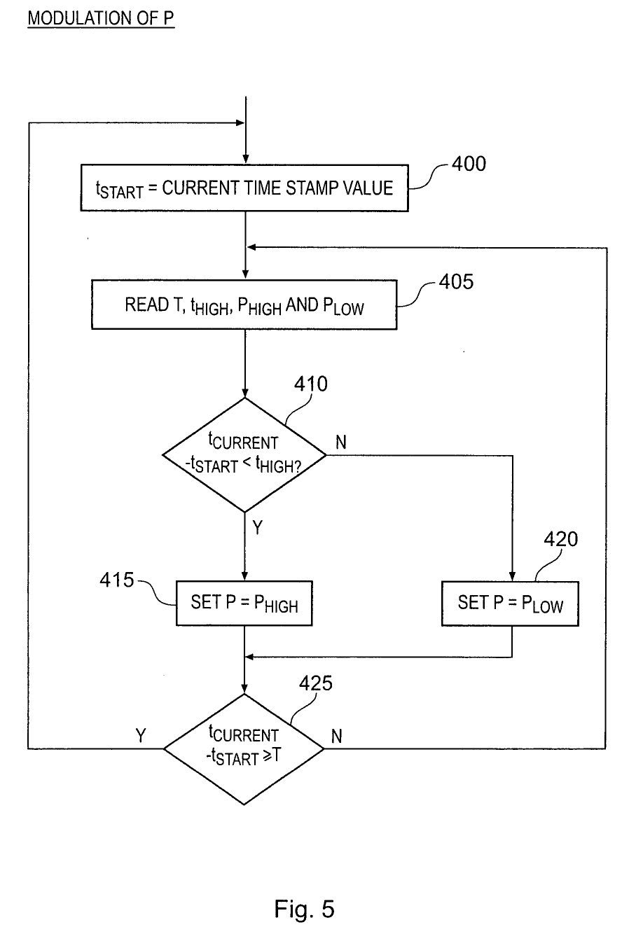

FIG. 5 illustrates a process that can be performed by the PWM module 180 in order to directly perform the modulation and to issue control signals to the frequency and voltage scaling hardware 160 identifying at any particular point the predetermined performance level that should be used. At step 400, a parameter t_{START} is set equal to a current time stamp value within the data processing system. Thereafter, at step 405, the parameters T, t_{HIGH}, P_{HIGH} and P_{LOW} are read from some internal storage holding those values, these parameters having been produced at step 335 of the calculation process discussed earlier with reference to FIG. 4.

Thereafter, at step 410, it is determined whether the difference between the current time and the time t_{START} is less than the parameter t_{HIGH}. If it is, then the process proceeds to step 415, where the performance level P is set equal to P_{HIGH}, an indication of the performance level P being output to the frequency and voltage scaling hardware 160. Similarly, if at step 410 it is determined that the difference between the current time and the time t_{START} is greater than or equal to t_{HIGH}, then the process proceeds to step 420 where the performance level P is set equal to P_{LOW}, and again an indication of the performance level P is output to the frequency and voltage scaling hardware 160. Following steps 415 or 420, the process proceeds to step 425, where it is determined whether the difference between the current time and the time t_{START} is greater than or equal to the modulation period T. If it is, the process returns to step 400 to reset the parameter t_{START}, whereas otherwise the process returns to step 405. As a result of the process performed in FIG. 5, it will be appreciated that during the modulation period T an average performance level P_{AVG} is achieved, where that average performance level is given by the equation:

P_{AVG}=(P_{HIGH}*t_{HIGH}+P_{LOW}*t_{LOW})/T

Further, with the parameter t_{HIGH} and the parameter t_{LOW} calculated in the manner described earlier with reference to FIG. 4, the average performance level P_{AVG} equates to the required processor performance level P_{CPU}.

There are a number of ways in which the modulation period can be determined in accordance with embodiments of the present invention. As the modulation period increases, the frequency of the switching between power levels decreases, and accordingly the energy consumed by the modulation process is reduced. However, the larger the modulation period, the longer the period of time that the processor is operated at the lower predetermined performance level P_{LOW}, and if the processor spends too long at level P_{LOW} it is possible that tasks will start to fail their deadline requirements, since P_{LOW} is less than the required processor performance level.

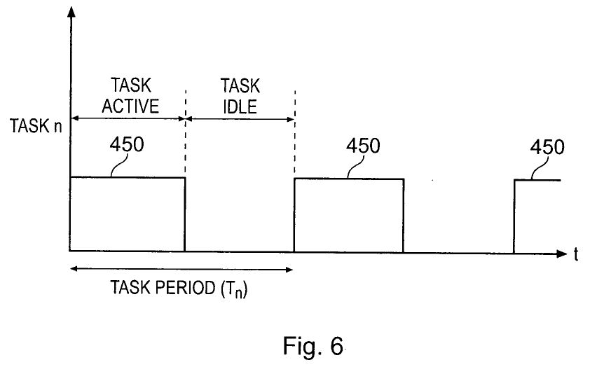

In accordance with one embodiment, the PWM module 180 is arranged to determine the modulation period by determining a task deadline for each currently active task, and then selecting as the modulation period the smallest of the determined task deadlines. The task deadline for any particular task corresponds to a time interval within which that task should have been completed by the data processing apparatus. FIG. 6 illustrates the scheduling of a particular active task n, blocks 450 illustrating times at which the task is scheduled. Each time the task is scheduled, it will have some quantum of processing to perform, and that quantum of processing must be performed whilst the task is scheduled. A task period Tₙ can be defined as the periodic interval at which the task n is scheduled by the scheduler 122. The scheduled period of the task 450 cannot exceed the task period, and indeed typically there will be a task idle period after the task 450 has completed its quantum of processing before the task is again scheduled at the end of the task period. For certain tasks, a timeout time will also be set specifying an acceptable response time for that task. This is particularly the case for interactive tasks where the timeout period may specify an acceptable response time for a user. In such instances, the task deadline will be the smallest of either the task period or the timeout period.

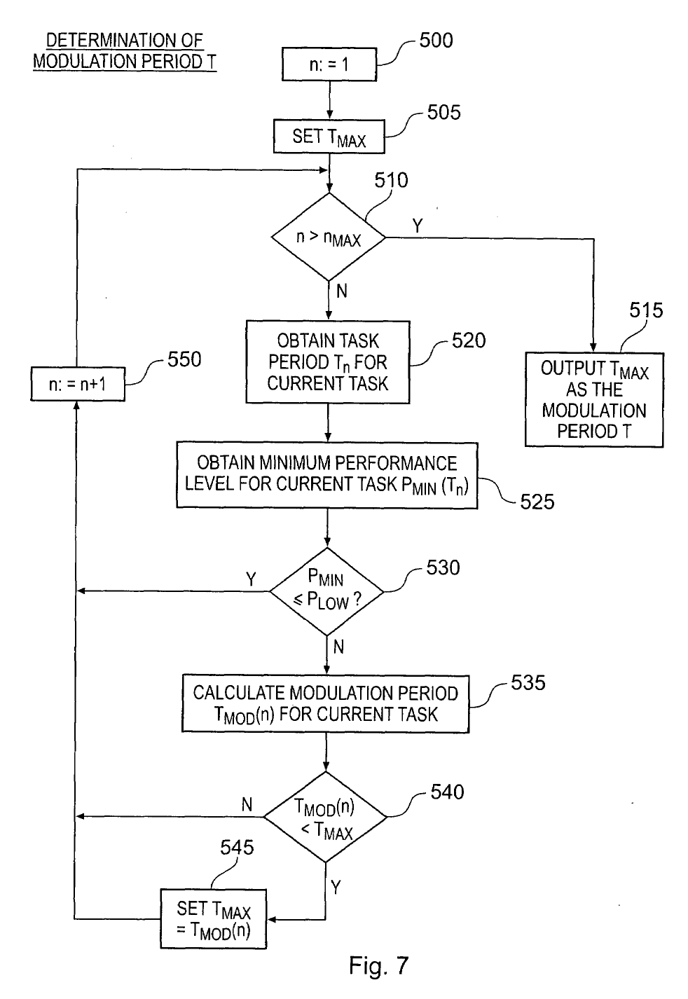

By evaluating the task deadline for each scheduled task, and then selecting as the modulation period the smallest of those task deadlines, this results in the determination of a modulation period which will ensure that any combination of active tasks will meet their deadline requirements. However, whilst such a technique ensures a suitable modulation period is selected, that modulation period may not in fact represent the maximum value that could be chosen whilst still enabling the deadline requirements to be met, and accordingly in such situations unnecessary energy consumption will be consumed by switching between the performance levels more often than is in fact needed. FIG. 7 illustrates an alternative technique that can be performed by the PWM module 180 in order to determine the modulation period in accordance with one embodiment of the present invention. As shown in FIG. 7, assuming there are n_{MAX} currently active tasks, parameter n is set equal to one at step 500 and at step 505 a maximum modulation period T_{MAX} is set. This value will typically be determined having regard to the particular system in which the technique is being implemented. For example, T_{MAX} can be chosen based on the heating and heat dissipation (cooling) graphs for the processor. The value of T_{MAX} should be chosen so that there are no large processor temperature variations during the t_{HIGH} and t_{LOW} periods. In practice, a safe value of T_{MAX} may be simply selected based on a general understanding of the processor's operating behaviour.

Thereafter, at step 510, it is determined whether the current task number n is greater than n_{MAX}. On the first iteration, this will clearly not be the case, and the process will proceed to step 520, where the task period Tₙ is obtained for the current task. The PWM module 180 can obtain this information from the IEM kernel 152, with either the IEM kernel 152 or one of the performance level setting policies within the performance setting module 170 determining the task period based on the scheduling events received from the OS kernel 120. Thereafter, the PWM module 180 obtains a minimum performance level for the current task P_{MIN}(Tₙ). This minimum processor performance level can be obtained in a variety of ways. For example, if the scheduler 122 is a Rate Monotonic scheduler, then the P_{MIN} value is given by the equation:

P_{MIN}(Tₙ)=sum(Pᵢ)/U(n) for every task i with Tᵢ≦Tₙ and

U(n)=n*(2^{1/n}−1)

where Pᵢ is the processor workload corresponding to the task i, and U(n) is the CPU utilisation and calculated according to the task scheduling algorithm.

As another example, if the scheduler 122 is an Earliest Deadline First scheduler, then the minimum performance level can be calculated by the following equation:

P_{MIN}(Tₙ)=sum(Pᵢ) for every task i with Tᵢ≦Tₙ

where Pᵢ is the processor workload corresponding to the task i.

As another example, assuming a general purpose scheduler is used as the scheduler 122, the first performance level setting policy described in the earlier-mentioned U.S. patent application Ser. No. 11/431,928 (that dynamically calculates a performance level in dependence upon a quality of service value for a processing task) can directly produce the required minimum performance level P_{MIN} (Tₙ) required at step 525. The calculation of an fₘᵢₙi value is described therein, and the PMN value can be calculated as follows:

P_{MIN}=fₘᵢₙi/f_{MAX}

where f_{MAX} is the maximum frequency accepted by the processor.

The minimum performance level obtained at step 525 is representative for the current task n running in combination with all other active tasks, and its value will vary depending on the OS scheduling algorithm as discussed above and the constraints imposed on the tasks (e.g. deadline, quality of service).

Following step 525 the process proceeds to step 530, where it is determined whether the minimum performance level is less than or equal to the lower predetermined performance level P_{LOW}. If it is, then no further action is required since the task's minimum performance level will be met even if that task is performed in its entirety during the period when the processor is operating at the lower performance level P_{LOW}, and accordingly the process merely proceeds to step 550 where the value of n is incremented and then the process returns to step 510.

However, if it is determined that the minimum performance level is not less than or equal to P_{LOW}, then the process proceeds to step 535 where a modulation period T_{MOD}(n) is calculated for the current task.

The minimum average performance for an interval t in the system is:

P_{MIN}(t)=P_{LOW} if t<=t_{LOW}

P_{MIN}(t)=[P_{HIGH}*(t−t_{LOW})+P_{LOW}*t_{LOW}]/t if t>t_{LOW}

i.e. P_{MIN}(t)=P_{HIGH}*(1−t_{LOW}/t)+P_{LOW}*(t_{LOW}/t)

Given a P_{MIN}(t) for a given interval t, the corresponding maximum t_{LOW} is:

t_{LOW}=[P_{HIGH}−P_{MIN}(t)]/(P_{HIGH}−P_{LOW})*t

From the above equation and the fill factor parameters, the modulation period is:

T=[P_{HIGH}−P_{MIN}(t)]/(P_{HIGH}−P_{CPU})*t

For the quality of service requirements to be met for any combination of tasks, the t interval does not need to be smaller than the minimum task period of any task in the system. Since P_{LOW}<=P_{MIN}(t)<=P_{CPU}, from the above conditions T>=t and therefore the modulation period is greater or equal to the minimum task period of any task in the system.

Accordingly, from the above equations it will be seen that the modulation period T_{MOD}(n) for a current task can be calculated according to the equation:

T_{MOD}(n)=[P_{HIGH}−P_{MIN}(Tₙ)]/[P_{HIGH}−P_{CPU}]*Tₙ

where:
T_{MOD}(n) is the task modulation period;
P_{HIGH} is a selected first predetermined processor performance level above said required processor performance level;
P_{MIN}(Tₙ) is the minimum processor performance level for the task;
P_{CPU} is the required processor performance level; and
Tₙ is the task deadline.

At step 540, it is determined whether the modulation period T_{MOD}(n) calculated at step 535 is less than the current value of T_{MAX}, and if it is the value of T_{MAX} is updated at step 545 to be equal to the T_{MOD}(n) value. Thereafter, the process proceeds to step 550 where n is incremented before returning to step 510, and indeed proceeds directly to step 550 from step 540 if it is determined that the modulation period is not less than the current T_{MAX} value.

The process described in FIG. 7 continues until it is determined that n is greater than n_{MAX} at step 510, at which point all tasks have been evaluated, and then the process branches to step 515 where the current value of T_{MAX} is output as the modulation period T.

In accordance with the technique described above, the modulation period determined will be larger than or at least equal to the smallest of the determined task deadlines, and hence allows a modulation period which is greater than or equal to the smallest of the determined task deadlines without having any adverse effect on the meeting of deadline requirements for any combination of active tasks in the system. Hence, using such an approach to calculate the modulation period can reduce the energy consumed in performing the modulation by enabling a value of the modulation period to be determined which is larger than would otherwise be the case if merely the smallest of the determined task deadlines were chosen as the modulation period.

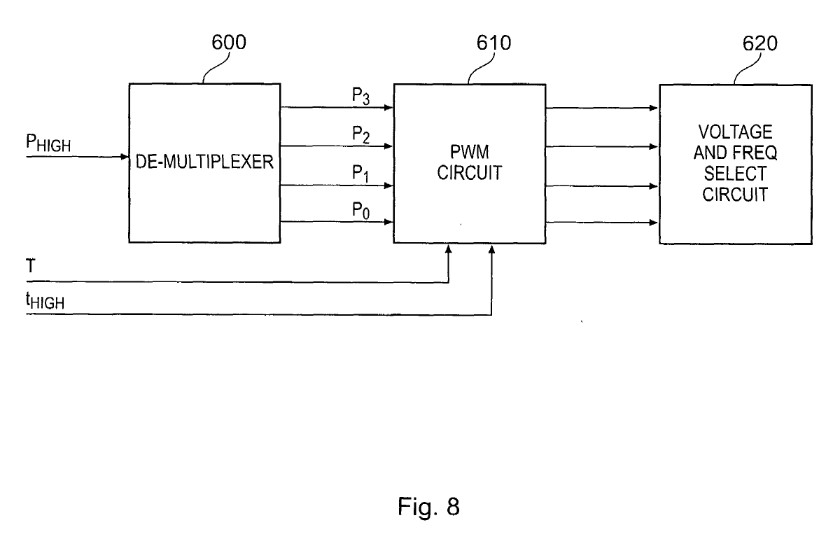

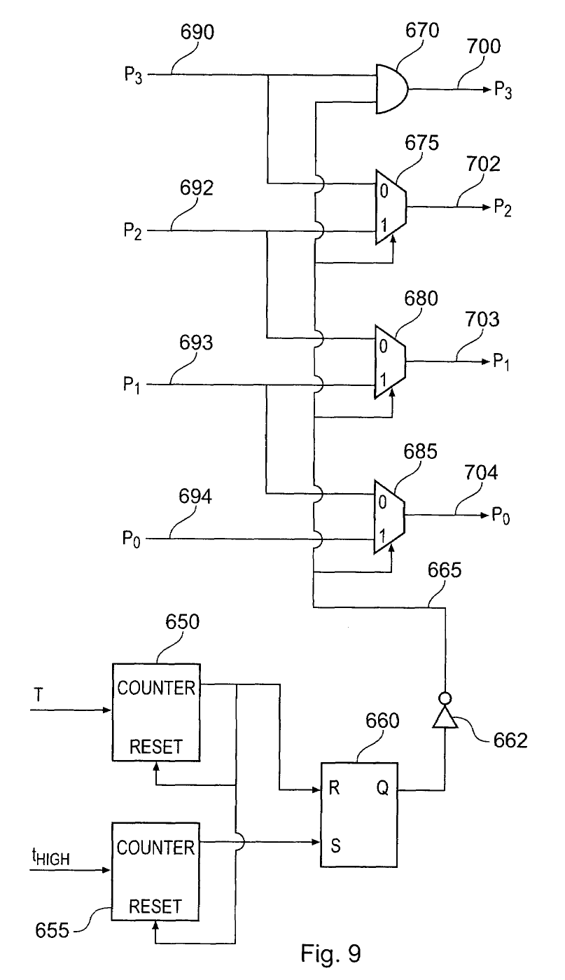

FIG. 5 discussed earlier described a technique for performing the required modulation between the two selected performance levels P_{HIGH} and P_{LOW}. Whilst the process of FIG. 5 could be employed by software within the PWM module 180, it can in alternative embodiments be performed by hardware circuitry within the frequency and voltage scaling hardware 160. FIG. 8 illustrates one such hardware embodiment of the frequency and voltage scaling hardware 160, where that hardware is provided with the parameters P_{HIGH}, T and t_{HIGH} calculated by the PWM module 180. The hardware 160 includes a de-multiplexer 600 which receives the P_{HIGH} value and based thereon enables one of the lines into the PWM circuit 610. In the example illustrated in FIG. 8, there are four predetermined performance levels P₃, P₂, P₁ and P₀, where P₃ is the highest performance level and P₀ is the lowest performance level. The PWM circuit 610 receives the time parameters T and t_{HIGH} and based thereon generates appropriate drive signals to the voltage and frequency select circuit 620. In particular, the PWM circuit 610 will drive a control line into the voltage and frequency select circuit 620 corresponding to the performance level P_{HIGH} for a first part of the modulation period T, and will drive a control line into the select circuit 620 for the remainder of the modulation period corresponding to the performance level P_{LOW}, which can be inferred from the P_{HIGH} value received. More details of the PWM circuit 610 are shown in FIG. 9.

FIG. 9 shows one embodiment of the PWM circuit 610. The de-multiplexer 600 will assert one of the input lines 690, 692, 693, 694 high dependent on the value of the P_{HIGH} signal received by the de-multiplexer. Control logic in the form of two counters 650, 655, a latch 660 and an inverter 662 will generate a control signal over path 665. In particular, the counter 650 receives the value of the modulation period T from a register and the counter 655 receives the value of the parameter t_{HIGH} from a register. The counters (which can be incrementing or decrementing counters) both begin counting at the start of the modulation period and when they reach a count value corresponding to their input value, they output a logic one value. Accordingly, when the counter 655 has counted the period expressed by the parameter t_{HIGH}, it outputs a logic one value to the set input of the latch 660. Similarly, when the counter 650 has counted the modulation period T, it outputs a logic one value to the reset input of the latch 660. Further, the logic one value output by the counter 650 at that time is used to reset both the counter 650 and the counter 655. The latch 660 initially outputs a logic zero level from its Q output which is inverted by the inverter 662 to drive a logic one value over the path 665. When the logic one value is received from the counter 655, this causes the Q output to change to a logic one value which is inverted by the inverter 662 to generate a logic zero value on the path 665. When the logic one value is subsequently output by the counter 650 at the end of the modulation period, this resets the Q output to a logic zero value.

Accordingly, it can be seen that during the first part of the modulation period corresponding to the time t_{HIGH}, a logic one value appears over path 665, and for the remainder of the modulation period a logic zero value appears over the path 665. The signal appearing on path 665 is driven as one of the inputs to the AND gate 670, and is also used as the control signal for the multiplexers 675, 680, 685. Accordingly, irrespective of which one of the four input lines 690, 692, 693, 694 is driven high by the de-multiplexer 600, the corresponding output 700, 702, 703, 704 will be driven high during the first part of the modulation period, i.e. during the t_{HIGH} part. Then, during the remainder of the modulation period, the output path corresponding to the immediately lower performance level will be selected by the appropriate logic gates 670, 675, 680, 685. As an example, if the P₃ level is asserted high over control line 690, then during the first part of the modulation period, both inputs to the AND gate 670 will be at a logic one level, which will cause a logic one level to be output over path 700. When the counter 655 reaches the count value associated with t_{HIGH}, this will cause a logic zero value to be output over path 665 which will turn off the AND gate 670 and will cause the multiplexer 675 to output over path 702 the input received over path 690. Accordingly, for the remainder of the modulation period the control line 702 associated with performance level P₂ will be asserted.

Accordingly, it will be seen that the embodiment illustrated in FIGS. 8 and 9 provides one example implementation of hardware modulation circuitry within the frequency and voltage scaling hardware 160 of FIG. 2.

From the above described embodiments of the present invention, it will be seen that such embodiments improve the energy savings that can be achieved in systems supporting a plurality of predetermined processor performance levels by simulating intermediate performance levels other than those supported by the voltage and frequency supply circuits of the apparatus. In particular, a modulation is performed between two processor performance levels in order to achieve an average processor performance corresponding to the required processor performance level. By employing techniques in accordance with embodiments of the present invention, improved energy savings can be achieved in systems with a limited number of CPU performance levels without affecting the quality of service. Further, by using such techniques, it becomes easier to tune the performance setting policies in order to achieve a balance between energy saving and quality of service. In accordance with embodiments of the present invention, the pulse width modulation parameters are determined so that the system performs an optimal number of performance level switches whilst ensuring that the quality of service is not affected.

Appendix 1 below is the text of the embodiment description of copending U.S. application Ser. No. 11/431,928, and describes a technique which enables a minimum processor performance level to be calculated when using a general purpose scheduler.

### APPENDIX 1

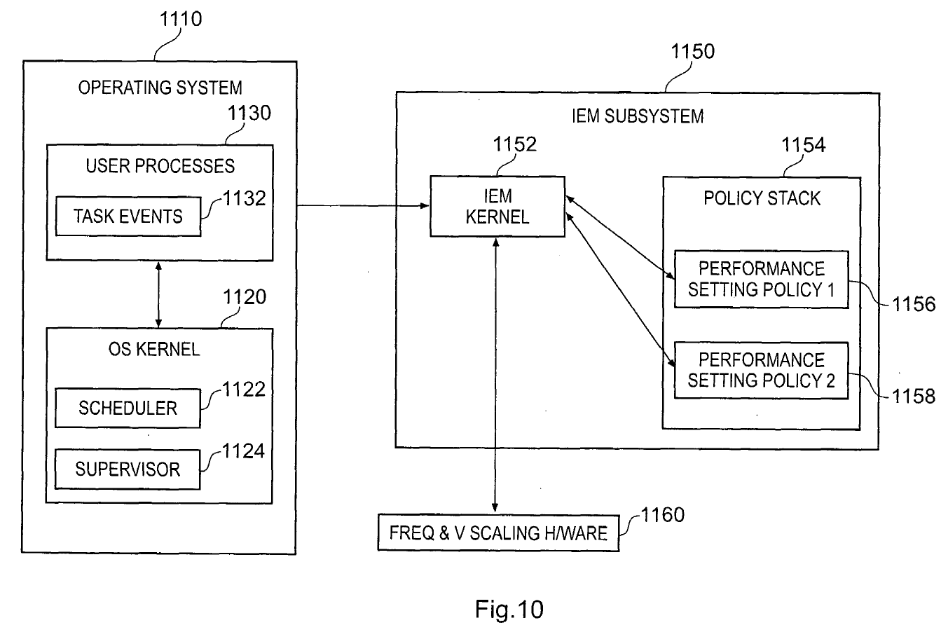

FIG. 10 schematically illustrates a data processing system capable of operating at a plurality of different performance levels and comprising an intelligent energy management subsystem operable to perform selection of a performance level to be used by the data processing system. The data processing system comprises an operating system 1110 comprising a user processes layer 1130 having a task events module 1132. The operating system 1110 also comprises an operating system kernel 1120 having a scheduler 1122 and a supervisor 1124. The data processing system comprises an intelligent energy management (IEM) subsystem 1150 comprising an IEM kernel 1152 and a policy stack having a first performance setting policy module 1156 and a second performance setting policy module 1158. Frequency and voltage scaling hardware 1160 is also provided as part of the data processing system.

The operating system kernel 1120 is the core that provides basic services for other parts of the operating system 1110. The kernel can be contrasted with the shell (not shown) which is the outermost part of the operating system that interacts with user commands. The code of the kernel is executed with complete access privileges for physical resources, such as memory, on its host system. The services of the operating system kernel 1120 are requested by other parts of the system or by an application program through a set of program interfaces known as a system core. The scheduler 1122 determines which programs share the kernel's processing time and in what order. The supervisor 1124 within the kernel 1120 provides access to the processor by each process at the scheduled time.

The user processes layer 1130 monitors processing work performed by the data processing system via system call events and processing task events including task switching, task creation and task exit events and also via application-specific data. The task events module 1132 represents processing tasks performed as part of the user processes layer 1130.

The intelligent energy management subsystem 1150 is responsible for calculating and setting processor performance levels. The policy stack 1154 comprises a plurality of performance level setting policies 1156, 1158 each of which uses a different algorithm to calculate a target performance level according to different characteristics according to different run-time situations. The policy stack 1154 co-ordinates the performance setting policies 1156, 1158 and takes account of different performance level predictions to select an appropriate performance level for a given processing situation at run-time. In effect the results of the two different performance setting policy modules 1156, 1158 are collated and analysed to determine a global estimate for a target processor performance level. In this particular embodiment the first performance setting policy module 1156 is operable to calculate at least one of a maximum processor frequency and a minimum processor frequency in dependence upon a quality of service value for a processing task. The IEM subsystem 1150 is operable to dynamically vary the performance range of the processor in dependence upon at least one of these performance limits (i.e. maximum and minimum frequencies). In the embodiment of FIG. 10, the policy stack 1154 has two performance setting policies 1156, 1158, but in alternative embodiments, additional performance setting policies are included in the policy stack 1154. In such embodiments where a plurality of performance setting policies are provided, the various policies are organised into a decision hierarchy (or algorithm stack) in which the performance level indicators output by algorithms at upper (more dominant) levels of the hierarchy have the right to override the performance level indicators output by lower (less dominant) levels of the hierarchy. Examples of different performance setting policies include: (i) an interactive performance level prediction algorithm which monitors activity to find episodes of execution that directly impact the user experience and ensures that these episodes complete without undue delay; (ii) an application-specific performance algorithm that collates performance information output by application programs that have been adapted to submit (via system calls) information with regard to their specific performance requirements to the IEM subsystem 1150; and (iii) a perspectives based algorithm that estimates future utilisation of the processor based on recent utilisation history. Details of the policy stack and the hierarchy of performance request calculating algorithms are described in U.S. patent application Ser. No. 10/687,972, which is incorporated herein by reference. The first performance level setting policy 1156, which dynamically calculates at least one performance limit (minimum or maximum frequency) in dependence upon a quality of service value for a processing task, is at the uppermost level of the policy stack 1154 hierarchy. Accordingly, it constrains the currently selected processor performance level such that it is within the currently set performance limit(s) (maximum and/or minimum frequencies of range) overriding any requests from other algorithms of the policy stack 1154 to set the actual performance level to a value that is less than the minimum acceptable frequency or greater than the maximum acceptable frequency calculated by the first performance setting policy 1156. The performance setting policies of the policy stack 1154 can be implemented in software, hardware or a combination thereof (e.g. in firmware).

The operating system 1110 supplies to the IEM kernel 1152, information with regard to operating system events such as task switching and the number of active tasks in the system at a given moment. The IEM kernel 1152 in turn supplies the task information and the operating system parameters to each of the performance setting policy modules 1156, 1158. The performance setting policy modules 1156, 1158 use the information received from the IEM kernel in order to calculate appropriate processor performance levels in accordance with the respective algorithm. Each of the performance setting policy modules 1156, 1158 supplies to the IEM kernel a calculated target performance level and the IEM kernel manages appropriate selection of a global target processor performance level. The performance level of the processor is selected from a plurality of different possible performance levels. However, according to the present technique, the range of possible performance levels that can be selected by the IEM kernel is varied dynamically in dependence upon run-time information about the required quality of service for different processing tasks. The frequency and voltage scaling hardware 1160 supplies information to the IEM kernel with regard to the currently set operating frequency and voltage whereas the IEM kernel supplies the frequency and voltage scaling hardware with information regarding the required target frequency, which is dependent upon the current processing requirements. When the processor frequency is reduced, the voltage may be scaled down in order to achieve energy savings. For processors implemented in complimentary metal-oxide semiconductor (CMOS) technology, the energy used for a given work load is proportional to voltage squared.

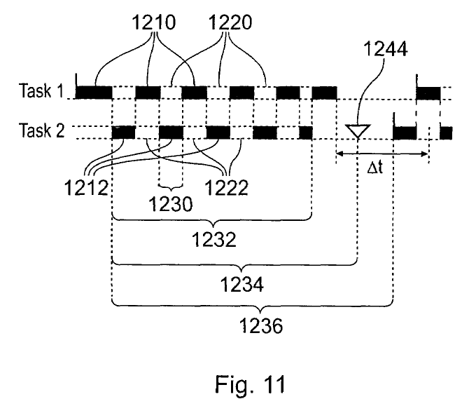

FIG. 11 schematically illustrates execution of two different processing tasks in the data processing system of FIG. 10. The horizontal axis for each of the tasks in FIG. 11 represents time. As shown in FIG. 11, each task is executed as a plurality of discrete scheduling periods 1210, which are separated by waiting periods 1220. During the waiting periods other currently executing processing tasks are scheduled by the data processing system. In this case where there are only two tasks currently executing in the data processing system it can be seen that the scheduling periods 1210 of task 1 coincide with the waiting periods 1222 of task 2 and conversely the scheduling periods of task 2 1212 coincide with the waiting periods 1220 of task 1.

In FIG. 11 a number of task-specific parameters are illustrated. In particular, the time period 1230 corresponds to the average task switching interval τ, which in this case corresponds to the typical duration an individual scheduling period. Note that a given scheduling “episode” comprises a plurality of scheduling periods. For example, for a program subroutine, each execution of the subroutine would correspond to a scheduling episode and the processing required to be performed for each scheduling episode will be performed during a number of discrete scheduling periods. Scheduling periods for a given task are punctuated by task switches by the processor. The time interval 1232 corresponds to the task completion time for task 2 and represents the time from the beginning of the first scheduling episode of processing task 2 to the end of the last scheduling period of processing task 2 (for a given scheduling episode), whereupon the task is complete. The task period or deadline corresponds to the time interval 1234. It can be seen from FIG. 11, that between the end of the task completion time interval 1232 and the task 2 deadline (i.e. the end of time period 1234) there is “slack time”. The slack time corresponds to the time between when a given task was actually completed and the latest time when it could have been completed yet still meet the task deadline. To save energy while preserving the quality of service in a system, we can only try to reduce the slack time, any further reduction in time and the deadline would be missed.

When the processor is running at full capacity many processing tasks will be completed in advance of their deadlines and in this case, the processor is likely to be idle until the next scheduled task is begun. A larger idle time between the completion of execution of a task and the beginning of the next scheduled event corresponds to a less efficient system, since the processor is running at a higher frequency than necessary to meet performance targets. An example of a task deadline for a task that produces data is the point at which the generated data is required for use by another task. The deadline for an interactive task would be the perception threshold of the user (e.g. 50-100 milliseconds). A convenient quality of service measure for interactive tasks involves defining the task deadline to be the smaller of the task period and a value specifying an acceptable response time for a user. Thus for those processing tasks for which the response time is important in terms of a perceived quality of service, the task deadline can be appropriately set to a value smaller than the task period.

Going at full performance and then idling is less energy-efficient than completing the task more slowly so that the deadline is met more exactly. However, decreasing the CPU frequency below a certain value can lead to a decrease in the “quality of service” for processing applications. One possible way of measuring quality of service for a particular processing task is to monitor the percentage of task deadlines that were met during a number of execution episodes. For periodic applications or tasks having short periods, the task deadline is typically the start of the next execution episode. For a periodic applications or periodic applications with long periods, the task deadline depends on whether the application is interactive (shorter deadline) or performs batch processing (can take longer).

In the case of FIG. 11, the estimated task period (i.e. which is greater than or equal to the task deadline) corresponds to the time interval 1236. The idle time of the device corresponds to the time between the end of the completion time 1232 and the end of the estimated period T 1236. Thus, the slack time is included within the idle time and in the case of the deadline being equal to the estimated period, i.e. 1234 and 1236 being the same, the idle time and slack time are the same. The time point 1244 corresponds to the task deadline by which the task ought to have completed a predetermined amount of processing. However, the first performance setting policy module 1156 of FIG. 10 can allow for a tolerance in meeting a given task deadline by defining a tolerance window about the upper limit 1244 of the task deadline, such a window is shown in FIG. 11 and indicated by Δt. This provides more flexibility in setting the current processor performance level, particularly where the data processing system allows for a choice between a plurality of discrete processor performance levels rather than allowing for selection from a continuous range.

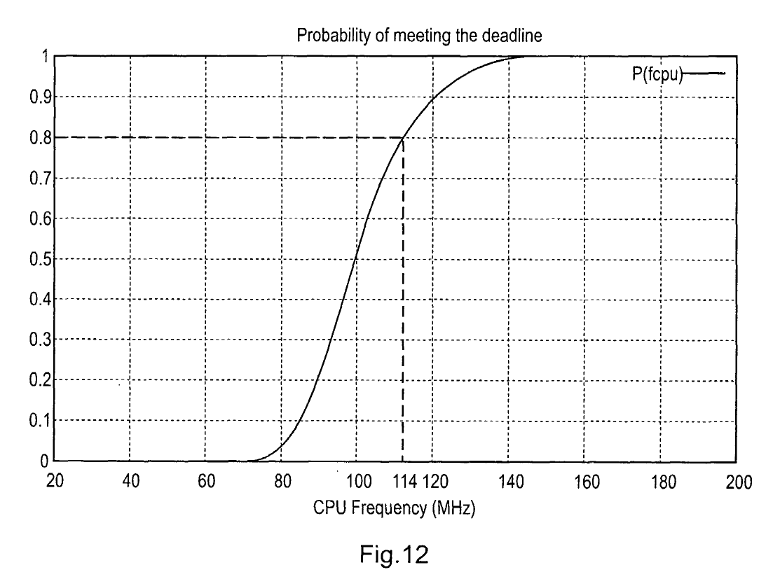

FIG. 12 is a graph of the probability of meeting the task deadline (y-axis) against the processor frequency in MHz (x-axis). In this example the total number of active tasks in executing on the data processing system is two (as for FIG. 11) and the task switching interval is 1 millisecond (ms). The maximum processor frequency in this example is 200 MHz. The task to which the probability curve applies has a task period or deadline of 0.1 seconds (100 ms) and a task switching rate of 500 times per second. It can be seen that, in this particular example, the probability of meeting the task deadline for processor frequencies of less than about 75 MHz is substantially zero and the probability of meeting the deadline increases approximately linearly in the frequency range from 85 MHz to 110 MHz. The probability curve then flattens off between frequencies of 110 MHz and 160 MHz. For frequencies of 160 MHz and above, the task is almost guaranteed to meet its task deadline, since the probability closely approaches one.

Consider the case where the first performance setting policy 1156 of the IEM subsystem 1150 of FIG. 10 specifies that for the task corresponding to the probability curve of FIG. 12, an acceptable probability of meeting the task deadline corresponds to a probability of 0.8. From the probability curve (FIG. 12) it can be seen that an appropriate minimum processor frequency fₘᵢₙi to achieve this probability of meeting the deadline is 114 MHz. Thus the task-specific lower bound fₘᵢₙi for the CPU frequency is 114 MHz. However, the global lower CPU frequency bound will depend upon a similar determination being performed for each of the concurrently scheduled tasks.

For the task associated with the probability curve of FIG. 12, it can be seen that decreasing the processor frequency below 140 MHz leads to a corresponding decrease in quality of service. In general, the probability of meeting a task deadline progressively diminishes as the processor frequency decreases. The probability for a given task to hit its deadline is clearly a function of the processor frequency. However, this probability is also a function of other system parameters such as: the number of running tasks in the system; the scheduling resolution; task priorities and so on. According to the present technique the frequency range from which the IEM kernel 1152 can select the current frequency and voltage of the processor is dynamically varied and restricted in dependence upon a probability function such as that of FIG. 12. However, it will be appreciated that the probabilities of meeting deadlines for a plurality of tasks can be taken into account and not just the probability of meeting the deadline for an individual task.

Task scheduling events scheduled by the task scheduler 1122 of FIG. 10 typically have a Poisson distribution in time. This fact is used to determine the probability of hitting or missing a task deadline as a function of:

the processor frequency;

the task's required number of cycles for completion (determined stochastically);

the task's deadline;

the task's priority;

the scheduler resolution or task switch interval; and

the number of tasks in the system.

An equation describing the probability function such as the probability function plotted in FIG. 12 is used to derive an inverse probability which can then be used to calculate an appropriate processor frequency for a given probability of missing or meeting the task deadline. We will now consider in detail how the desired frequency limit is calculated and how the probability function of FIG. 12 is derived in this particular embodiment.

The probability of a given processing task hitting (or missing) its task deadline is calculated by the first performance setting policy module in dependence upon both operating system parameters and task-specific parameters.

For a task i scheduled for execution by the data processing system, the following task-specific parameters are relevant in order to calculate the minimum acceptable processor frequency (fₘᵢₙi) that enables the task deadline to be hit for the individual processing task i:
Cᵢ the number of processing cycles needed to be executed on behalf of the task before its deadline;
Tᵢ the task deadline (usually equivalent to the period if the period is not large);
αᵢ scheduler priority parameter; and
Pₕ_{ᵢ} the probability for a task to hit the deadline;
   The system (global) parameters are:
f_{CPU} the CPU frequency; and
n the number of active tasks in the system at a given moment.

Assuming that there are n tasks active in a t seconds interval and a task switch occurs every τ seconds (τ is of an order of μs or ms), the number of periods a specific task is scheduled in (Nₜ), follows a Poisson distribution with the following probability mass function:

$$P ( {N = k}_{t} ) = {f}_{p} ( k ; λ t ) = \frac{{{e}^{- λ t} ( λ t )}^{k}}{k !} \qquad ( eqn 1 )$$

where λ is the rate or the expected number of task switches for a specific task in a time unit:

$$\begin{matrix}λ = \frac{ρ}{τ} & ( eqn 2 ) \\ E [ {N}_{t} ] = λ t , var ( {N}_{t} ) = λ t \\ and & ( eqn 3 ) \\ ρ = \frac{{α}_{i}}{{\sum }_{j = 1}^{n} {α}_{j}} & ( eqn 4 )\end{matrix}$$

ρ is the CPU share allocated by the OS scheduler to a specific task. Note that for equal priority tasks, αᵢ=1∀i= . . . n and ρ=1/n. α is a task priority parameter. It is an operating system (or scheduler) specific parameter associated to each task. It is not simple to calculate, whereas ρ can be statistically determined.

If M and N are two independent Poisson distributed random variables with λ_{M} and λ_{N} rates, the resulting M+N variable is Poisson distributed as well, with a λ_{M}+λ_{N} rate. This property of the Poisson variables simplifies the case when the number of tasks in the system is not constant in a period T, the resulting variable being Poisson distributed with a

$$\frac{1}{T} {\sum }_{i} {λ}_{i} {t}_{i}$$

rate.

The Poisson distribution, can be approximated by a normal distribution (the bigger λt, the better the approximation):

$${f}_{n} ( k ; μ , σ ) = \frac{1}{σ \sqrt{2 n }} {e}^{- \frac{{( k - μ )}^{2}}{2 {σ}^{2}}} \qquad ( eqn 5 )$$

P(Nₜ≦k)≅Fₙ(k) (eqn 6)

where μ=λt, σ²=λt and Fₙ(x) is the cumulative normal distribution function:

$${F}_{n} ( x ) = \frac{1}{\sqrt{2 π}} {\int }_{- ∞}^{x} {e}^{- \frac{{( u - μ )}^{2}}{2 {σ}^{2}}} d u \qquad ( eqn 7 )$$

For small values of λt, the approximation can be improved using a 0.5 continuity correction factor.

A random normal variable X is equivalent to a standard normal variable

$$Z = \frac{X - μ}{σ}$$

having the following cumulative distribution function:

$$Φ ( z ) = \frac{1}{\sqrt{2 π}} {\int }_{- ∞}^{z} {e}^{- \frac{{u}^{2}}{2}} d u \frac{1}{2} [ 1 + erf ( \frac{z}{\sqrt{2}} ) ] \qquad ( eqn 7 )$$

where erf(x) is the error function (monotonically increasing):

$$erf ( x ) = \frac{2}{\sqrt{π}} {\int }_{0}^{x} {e}^{- {t}^{2}} d t \qquad ( eqn 8 )$$

with the following limits: limits: erf(0)=0, erf(−∞)=−1, erf(∞)=1. The error function and its inverse can be found pre-calculated in various mathematical tables or can be determined using mathematics software packages such as Matlab^{RTM}, Mathematica^{RTM} or Octave^{RTM}.

The approximated cumulative Poisson distribution function becomes:

$$P ( {N}_{t} \leq k ) ≅ \frac{1}{2} [ 1 + erf ( \frac{k - λ t}{\sqrt{2 λ t}} ) ] \qquad ( eqn 9 )$$

where λ is the expected number of task switches for task i in a given time; Nₜ is the random number representing the scheduling events; k is the number of occurrences of the given event; and P(Nₜ≦k) is the probability that Nₜ is less than or equal to a given k, that is the probability of missing the deadline, i.e. the probability that the number of times a task was scheduled in is less than “k” the number required to complete its job—C cycles and t is time in seconds.

If the probability of a task i missing the deadline is Pₘ then it follows that the probability of hitting the deadline, Pₕ=1−Pₘ.

If C is the number of cycles that should be executed on behalf of a specific task in a period of time T then the number of times (k) that a task i needs to be scheduled so that the deadline is not missed is:

$$k = \frac{C}{τ {f}_{CPU}} \qquad ( eqn 10 )$$

where τ is the task switching period in seconds and f_{CPU} is the current processor frequency.

The probability of missing the deadline becomes:

$$\begin{matrix}{P}_{m} = p ( {N}_{t} \leq k ) ≅ {F}_{n} ( k ) \\ = Φ ( \frac{k - λ T}{\sqrt{λ T}} ) \\ = \frac{1}{2} [ 1 + erf ( \frac{k - λ T}{\sqrt{2 λ T}} ) ]\end{matrix} \qquad ( eqn 11 )$$

In terms of an individual task i, the processor (CPU) workload W for task i is given by:

$$W = \frac{C}{T {f}_{CPU}} ⇒ k = \frac{W T}{τ} \qquad ( eqn 12 )$$

Since λ=ρ/τ (where λ is the expected number of task switches in a given time; ρ is the CPU share allocated by the OS scheduler 1122 to task i; and τ is the task switching period in seconds), the probability Pₘ of missing the task deadline for an individual task is given by:

$${P}_{m} = \frac{1}{2} [ 1 + erf ( \frac{1}{\sqrt{2 ρ τ}} ( W - ρ ) \sqrt{T} ) ] \qquad ( eqn 13 )$$

From the above equation for Pₘ, it can be seen that for tasks having the same priority and the same period, those tasks having a higher associated individual CPU workload have a greater likelihood of missing the task deadline. Furthermore, considering tasks having the same CPU workload, those tasks with longer periods (T) have a higher probability of missing the task deadline.

Since the probability of hitting the deadline (Pₕ=1−Pₘ) is fixed, the above equations lead to a linear equation in k:

$$\frac{k - λ T}{\sqrt{λ T}} = {z}_{m} ⇒ k = λ T + {z}_{m} \sqrt{λ T} = ρ \frac{T}{τ} + {z}_{m} \sqrt{ρ \frac{T}{τ}} \qquad ( eqn 14 )$$

where the inverse probability function zₘ for the probability of missing the task deadline is given by:

zₘ=Φ⁻¹(Pₘ)=\sqrt{2}erf¹(2Pₘ−1) (eqn 15)

From the above equations, the CPU frequency for a given probability of missing the deadline is given by:

$${f}_{CPU} = \frac{C}{τ k} = \frac{C}{ρ T + {z}_{m} \sqrt{ρ T τ}} \qquad ( eqn 16 )$$

where C is the number of cycles that should be executed on behalf of a specific task in a period of time T; k is the number of times that a task i needs to be scheduled so that the deadline is not missed; T is a period of time corresponding to the task deadline (typically equal to the task period); η is the CPU share allocated by the OS scheduler 1122 to task i;. τ is the task switching period in seconds; and zₘ is the inverse probability function for the likelihood of missing the task deadline.

According to the algorithm implemented by the first performance setting policy module 1156 of FIG. 10, every task in the system is assigned a maximum acceptable probability of missing the deadline (minimum acceptable probability of hitting the deadline). The actual predetermined acceptable probability that is assigned to each task can be specified by the user and is dependent upon the type of processing task e.g. processing tasks that involve user interaction will have a high minimum acceptable probability of hitting the deadline to ensure that the response time is acceptable to the user whereas processing tasks that are less time-critical will be assigned lower minimum acceptable probabilities. For example, a video player application running on the machine requires good real-time response, while an email application does not.

For simplification, this probability can only take certain predetermined discrete values within a range. Based on these predetermined values, the inverse probability function zₘ (see eqn 15 above) is calculated and stored in memory (e.g. as a table) by the data processing system of FIG. 10.

The first performance setting policy module 1156 of FIG. 10 is operable to calculate and track the processor workload W (see eqn 12 above) and period T for each individual processing task i. Based on these values of W and T and the system parameters (e.g. n and f_{CPU}), the module calculates the minimum CPU frequency fₘᵢₙi so that for each of the n scheduled tasks, the probability of missing the deadline Pₘ is smaller than the predetermined acceptable Pₘ associated with the respective task. Thus the lower bound for the system CPU frequency f_{CPU}^{min} corresponds to the largest of the n individual task-specific minimum CPU frequencies fₘᵢₙi.

The constants τ (CPU share allocated by the OS scheduler to task i) and ρ (the (the task switching period in seconds) are statistically determined by the IEM subsystem at run-time.

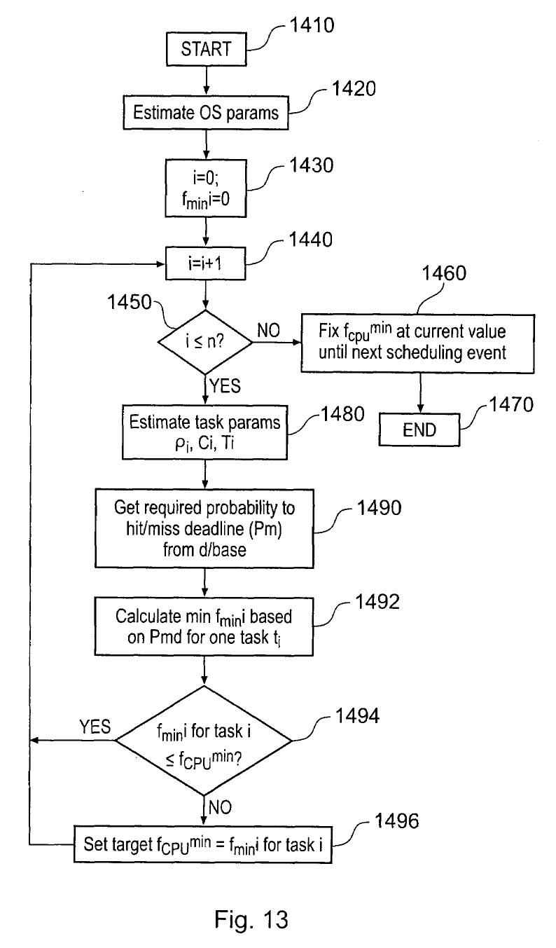

FIG. 13 is a flow chart that schematically illustrates how the first performance setting policy 1156 of FIG. 10 performs dynamic frequency scaling to dynamically vary the performance range from which the IEM kernel 1152 can select a plurality of possible performance levels. The entire process illustrated by the flow chart is directed towards calculating the minimum acceptable processor frequency f_{CPU}^{min} that enables the probability of meeting task deadlines for each of a plurality of concurrently scheduled processing tasks to be within acceptable bounds. The minimum acceptable frequency f_{CPU}^{min} represents the maximum of the frequencies calculated as being appropriate for each individual task. The value f_{CPU}^{min} represents a lower bound for the target frequency that can be output by the IEM kernel 1152 to the frequency and voltage scaling module 1160 to set the current processor performance level. The value f_{CPU}^{min} is calculated dynamically and it is recalculated each time the OS kernel 1120 of FIG. 10 performs a scheduling operation.

Note that in alternative embodiments, an upper bound f_{CPU}^{max} is calculated instead of or in addition to a lower bound. The upper bound f_{CPU}^{max} is calculated based on task-specific maximum frequencies fₘₐₓi, which are based on a specified upper bound for the required probability of meeting the task deadline associated with that task. The global value f_{CPU}^{max} represents the smallest of the task-specific maximum frequencies fₘₐₓi and should be larger than f_{CPU}^{min} to avoid increasing the probability of missing the deadline for some tasks. The goal of a good voltage-setting system is to arrive at a relatively stable set of predictions and avoid oscillations. The advantage of introducing an upper bound for the maximum frequency is that it helps the system arrive at a relatively stable set of predictions (avoiding or at least reducing oscillations). Oscillations waste energy, it is desirable to arrive at a correct stable prediction as early as possible.

Referring to the flow chart of FIG. 13, the process starts at stage 1410 and proceeds directly to stage 1420 where various operating system parameters are estimated by the first performance setting policy module 1156 based on information supplied to the IEM kernel 1152 by the operating system 1110. The operating system parameters include the total number of tasks currently scheduled by the data processing system and the current processor frequency f_{CPU}. Next, at stage 1430, the task loop-index i is initialised and the global minimum processor frequency f_{CPU}^{min} is set equal to zero.

At stage 1440, the task loop-index i is incremented and next at stage 1450 it is determined whether or not i is less than or equal to the total number of tasks currently running in the system. If i exceeds the number of tasks in the system, then the process proceeds to stage 1460 whereupon f_{CPU}^{min} is fixed at its current value (corresponding to the maximum value for all i of fₘᵢₙi) until the next task scheduling event and the process ends at stage 1470. The policy stack 1154 will then be constrained by the first performance setting policy to specifying to the IEM kernel a target processor performance level f_{CPU}^{target} that is greater than or equal to f_{CPU}^{min}.

However, if at stage 1450 it is determined that i is less than the total number of tasks currently running in the system then the process proceeds to stage 1480 whereupon various task-specific parameters are estimated. In particular, the following task-specific parameters are estimated:

(i) ρᵢ—the CPU share allocated to task i by the operating system scheduler (this value depends on the priority of the task i relative to other currently scheduled tasks);

(ii) τ—the task switching period;

(iii) C—the number of cycles to be executed on behalf of task i before its deadline;

(iv) T—the task period or deadline associated with task i; and

(v) zₘ—the inverse probability function associated with the probability of meeting the task deadline for task i. It is determined (looked up in a table) at or after step 1490 (see FIG. 13) and corresponds to the Pₘ value for the given task.

Once the task-specific parameters have been estimated, the process proceeds to stage 1490 where the required (i.e. acceptable) probability to meet the deadline for the given task i is read from a database. The required probability will vary according to the type of task involved, for example, interactive applications will have different required probabilities from non-interactive applications. For some tasks, such as time-critical processing operations, the required probability of meeting the task deadline is very close to the maximum probability of one whereas for other tasks it is acceptable to have lower required probabilities since the consequences of missing the task deadline are less severe.

After the required probabilities have been established at stage 1490, the process proceeds to stage 1492, where the minimum processor frequency for task i (fₘᵢₙi) is calculated based on the corresponding required probability. The process then proceeds to stage 1494, where it is determined whether or not the task-specific minimum processor frequency calculated at stage 1492 is less than or equal to the current global minimum processor frequency f_{CPU}^{min}.

If the task-specific minimum processor frequency fₘᵢₙi greater than f_{CPU}^{min}, then the process proceeds to stage 1496 where f_{CPU}^{min} is reset to fₘᵢₙi. The process then returns to stage 1440, where i is incremented and fₘᵢₙi is calculated for the next processing task.

On the other hand, if at stage 1494 it is determined that fₘᵢₙ i is less than or equal to the currently set global minimum frequency f_{CPU}^{min}, then the process returns to stage 1440 where the value of i is incremented and the calculation is performed for the next processing task. After stage 1496 the process then returns to increment the current task at stage 1440.

Although the described example embodiments use the probabilities that processing tasks will meet their task deadlines as a metric for the quality of service of the data processing system, alternative embodiments use different quality of service metrics. For example, in alternative embodiments the quality of service can be assessed by keeping track of the length, task deadline and speed for each execution episode for each processing task to establish the distribution of episode lengths. By speed “required speed” that would have been correct for an on-time execution of an episode is meant. After having executed an episode one can look back and figure out what the correct speed would have been in the first place is then used to determine the minimum episode length and speed that is likely to save useful amounts of energy. If a performance level prediction lies above the performance-limit derived in this way then the processor speed is set in accordance with the prediction. On the other hand, if the prediction lies below the performance-limit then a higher minimum speed (performance-range limit) is set in order to reduce the likelihood of misprediction.

In the particular embodiment described with reference to the flow chart of FIG. 13, the probability measure is calculated in dependence upon a particular set of system parameters and task-specific parameters. However, it will be appreciated that in different embodiments various alternative parameter sets are used to derive the probability measure. Parameters that reflect the state of the operating system of the data processing apparatus are particularly useful for deriving probability measures. Examples of such parameters include many different things, such as how much page swapping is going on, how much communication between tasks is occurring, how often system calls are being invoked, the average time consumed by the OS kernel, the external interrupts frequency, DMA activities that might block the memory access, cold/hot caches and TLBs.

Although a particular embodiment has been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

We claim:

1. A method of managing performance of a processor in a data processing apparatus, a plurality of predetermined processor performance levels being provided at which the processor may operate, the method comprising the steps of:
receiving an indication of a required processor performance level;
determining a modulation period;
selecting, dependent on the required processor performance level, multiple of said predetermined processor performance levels;
performing a determination operation to determine for each selected predetermined processor performance level a proportion of said modulation period during which the processor should operate at that predetermined processor performance level; and
during the modulation period, performing a modulation operation to switch the processor between said selected predetermined processor performance levels as indicated by the proportions determined by the determination operation.

2. A method as claimed in claim 1, wherein:
said selecting step comprises selecting a first predetermined processor performance level higher than said required processor performance level and a second predetermined processor performance level lower than said required processor performance level.

3. A method as claimed in claim 2, wherein said determination operation determines a first part of the modulation period during which the processor is operated at one of said first or second predetermined processor performance levels, for the remainder of the modulation period the processor being operated at said other of said first or second predetermined processor performance levels.

4. A method as claimed in claim 3, wherein during said modulation period the processor is operated at said first predetermined processor performance level during the first part of the modulation period, and at the second predetermined processor performance level during the remainder of the modulation period.

5. A method as claimed in claim 1, wherein the data processing apparatus performs a plurality of tasks, and said step of determining the modulation period comprises:
for each of said tasks, determining a task deadline corresponding to a time interval within which said task should have been completed by said data processing apparatus; and
selecting as said modulation period the smallest of the determined task deadlines.

6. A method as claimed in claim 5, wherein said task deadline is associated with an interactive task and corresponds to a smallest one of: (i) a task period; and (ii) a value specifying an acceptable response time for a user.

7. A method as claimed in claim 1, wherein the data processing apparatus performs a plurality of tasks, and said step of determining the modulation period comprises:
for each of said tasks:
(i) determining a task deadline corresponding to a time interval within which said task should have been completed by said data processing apparatus;
(ii) receiving a minimum processor performance level for said task assuming said task deadline; and
(iii) if said minimum processor performance level is greater than the lowest of said selected predetermined processor performance levels, determining a task modulation period for said task;
selecting as said modulation period the smallest of said determined task modulation periods.

8. A method as claimed in claim 7, wherein at said step (iii) the task modulation period is determined by the equation:
T_{MOD}(n)=[P_{HIGH}−P_{MIN}(Tₙ)]/[P_{HIGH}−P_{CPU}]*Tₙ
where:
T_{MOD}(n) is the task modulation period;
P_{HIGH} is a selected first predetermined processor performance level above said required processor performance level;
P_{MIN}(Tₙ) is the minimum processor performance level for the task;
P_{CPU} is the required processor performance level; and
Tₙ is the task deadline.

9. A method as claimed in claim 1, wherein said indication of a required processor performance level is received from a performance setting routine executed by said processor.

10. A method as claimed in claim 9, wherein said performance setting routine applies a quality of service policy.

11. A method as claimed in claim 1, wherein each predetermined processor performance level has an associated operating frequency at which the processor is operated if that predetermined processor performance level is selected for the processor.

12. A method as claimed in claim 11, wherein each predetermined processor performance level further has an associated supply voltage provided to the processor if that predetermined processor performance level is selected for the processor.

13. A computer program product comprising a computer program on a computer readable medium which when executed on a data processing apparatus performs a method of managing performance of a processor, a plurality of predetermined processor performance levels being provided at which the processor may operate, the computer program performing the steps of:
receiving an indication of a required processor performance level;
determining a modulation period;
selecting, dependent on the required processor performance level, multiple of said predetermined processor performance levels;
performing a determination operation to determine for each selected predetermined processor performance level a proportion of said modulation period during which the processor should operate at that predetermined processor performance level; and
during the modulation period, performing a modulation operation to switch the processor between said selected predetermined processor performance levels as indicated by the proportions determined by the determination operation.

14. A data processing apparatus comprising:
processor means;
control means for operating the processor at a selected one of a plurality of predetermined processor performance levels;
means for determining a required processor performance level;
means for determining a modulation period;
means for selecting, dependent on the required processor performance level, multiple of said predetermined processor performance levels; and
means for performing a determination operation to determine for each selected predetermined processor performance level a proportion of said modulation period during which the processor should operate at that predetermined processor performance level;
the control means, during the modulation period, performing a modulation operation to switch the processor means between said selected predetermined processor performance levels as indicated by the proportions determined by the determination operation.

15. A data processing apparatus comprising:
a processor; and
control circuitry for operating the processor at a selected one of a plurality of predetermined processor performance levels;
the processor being arranged to perform operations to produce an indication of a required processor performance level, a modulation period, and to select, dependent on the required processor performance level, multiple of said predetermined processor performance levels, the processor further arranged to perform a determination operation to determine for each selected predetermined processor performance level a proportion of said modulation period during which the processor should operate at that predetermined processor performance level;
the control circuitry including modulation circuitry for performing, during the modulation period, a modulation operation to switch the processor between said selected predetermined processor performance levels as indicated by the proportions determined by the determination operation.
